(19) United States
(12) Patent Application Publication
(10) Pub. No.: US 2009/0128435 A1
(43) Pub. Date: May 21, 2009

(54) SLOT-COUPLED MICROSTRIP ANTENNA

(75) Inventor: Jr-Ren Jeng, Taipei (TW)

Correspondence Address: Workman Nydegger;1000 Eagle Gate Tower, 60 East South Temple, Salt Lake City, UT, 84111, US

(73) Assignee: SmartAnt Telecom Co., Ltd., Jhudong Township (TW)

(21) Appl. No.: 11/941,207

(22) Filed: Nov. 16, 2007

(51) Int. Cl. H01Q 13/10; H01Q 9/04

(52) U.S. Cl. 343/770; 343/700 MS

(57) ABSTRACT

A slot-coupled microstrip antenna includes a first substrate, a second substrate, and a support base. The first substrate having a first surface and a second surface, in which a ground surface that is formed on the first surface, and a plurality of slots are formed on the ground surface. A feeding network is formed on the second surface. A plurality of antenna corresponding to the slots are formed on the second substrate disposed above the first surface. The support base having two fillisters at two side of the support base. The design of slot structure often has adverse influence on cross polarization and a front-to-back ratio of antenna radiation. The support base having two fillisters of the slot-coupled microstrip antenna can effectively inhibit the influence on the cross polarization and raise the front-to-back ratio from the slots.

### BACKGROUND OF THE INVENTION

1. Field of Invention

The present invention relates to a microstrip antenna, and more particularly to a slot-coupled microstrip antenna.

2. Related Art

With the development of wireless communication technology, microstrip antenna technology has become the most rapidly developing one in the antenna field. The microstrip antennae have advantages of small size and low weight, and feature low bandwidth and low gain.

In a normal microstrip antenna design, the method of coupling power into a radiation element of the antenna is roughly classified into a direct-feed mode and an indirect-feed mode. The direct-feed mode uses a coaxial cable or a microstrip line to connect a signal transmission line and the radiation element of the antenna; the indirect-feed mode applies an electromagnetic coupling principle to transfer the power transmission between a signal feeding line and the radiation element of the antenna. Generally speaking, the indirect-feed mode provides more space for the combination of a feeding network and a related microwave circuit without destroying structural elements of the antenna. In addition, the stray radiation and stray coupling between the radiation element of the antenna and the feeding network will be reduced significantly.

The slot-coupled microstrip antenna is a common microstrip antenna indirect-feed device. The slot-coupled microstrip antenna uses the air between a microstrip antenna and a ground metal as the medium, which features broad bandwidth and high gain, and has barely any influence between the microstrip antenna and the feeding line. However, the design of slot structure often has adverse influence on cross polarization and a front-to-back ratio of antenna radiation.

### SUMMARY OF THE INVENTION

Accordingly, the present invention is directed to providing a slot-coupled microstrip antenna. Through a design on shape of a support base, a front-to-back ratio is increased effectively, and levels of co-polarization and cross polarization are inhibited effectively as well.

The slot-coupled microstrip antenna of the present invention includes a first substrate, a second substrate and a support base. The first substrate has a first surface and a second surface, in which a ground surface having a plurality of slots is formed on the first surface, and a feeding network is formed on the second surface. A plurality of microstrip antennae corresponding to the slots formed on second substrate above the first surface. A support base having two slots at two side of the support base disposed below the second surface is used to adjacent the edges of the two grooves to two edges of the first substrate. The slots may be in a geometrical shape such as a rectangle, square, and round. The two grooves extending from two sides of the support base may be in a geometrical shape such as L or arc.

In the slot-coupled microstrip antenna, the two grooves extending from the support base are adjacent to two edges of the first substrate. Therefore, backward radiation of the antenna generated by the slots is reflected to concentrate within an angle and scope of forward radiation of the antenna, and influence of sidelobe wave number is eliminated to increase the front-to-back ratio; moreover, the level of the cross polarization is also reduced.

As for features and examples of the present invention, the preferred embodiment will be illustrated in detail with reference to the accompanied drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a first embodiment of the present invention;

FIG. 2 is an exploded view of the first embodiment of the present invention;

FIG. 3 is a side view of the first embodiment of the present invention;

FIG. 4 is a schematic view of a second embodiment of the present invention;

FIG. 5A is a diagram showing the measurement of horizontal plane co-polarization of the prior art at the frequency of 3.3 GHz;

FIG. 5B is a diagram showing the measurement of horizontal plane co-polarization of the prior art at the frequency of 3.5 GHz;

FIG. 5C is a diagram showing the measurement of horizontal plane co-polarization of the slot-coupled microstrip antenna of the present invention at the frequency of 3.3 GHz;

FIG. 5D is a diagram showing the measurement of horizontal co-polarization of the slot-coupled microstrip antenna of the present invention at the frequency of 3.5 GHz;

FIG. 6A is a diagram showing the measurement of vertical plane co-polarization of the prior art at the frequency of 3.3 GHz;

FIG. 6B is a diagram showing the measurement of vertical plane co-polarization of the prior art at the frequency of 3.5 GHz;

FIG. 6C is a diagram showing the measurement of vertical plane co-polarization of the slot-coupled microstrip antenna of the present invention at the frequency of 3.3 GHz;

FIG. 6D is a diagram showing the measurement of vertical plane co-polarization of the slot-coupled microstrip antenna of the present invention at the frequency of 3.5 GHz;

FIG. 7A is a diagram showing the measurement of horizontal plane cross polarization of the prior art at the frequency of 3.3 GHz;

FIG. 7B is a diagram showing the measurement of horizontal plane cross polarization of the prior art at the frequency of 3.5 GHz;

FIG. 7C is a diagram showing the measurement of horizontal plane cross polarization of the slot-coupled microstrip antenna of the present invention at the frequency of 3.3 GHz;

FIG. 7D is a diagram showing the measurement of horizontal plane cross polarization of the slot-coupled microstrip antenna of the present invention at the frequency of 3.5 GHz;

FIG. 8A is a diagram showing the measurement of vertical plane cross polarization of the prior art at the frequency of 3.3 GHz;

FIG. 8B is a diagram showing the measurement of vertical plane cross polarization of the prior art at the frequency of 3.5 GHz;

FIG. 8C is a diagram showing the measurement of vertical plane cross polarization of the slot-coupled microstrip antenna of the present invention at the frequency of 3.3 GHz; and

FIG. 8D is a diagram showing the measurement of vertical plane cross polarization of the slot-coupled microstrip antenna of the present invention at the frequency of 3.5 GHz.

### DETAILED DESCRIPTION OF THE INVENTION

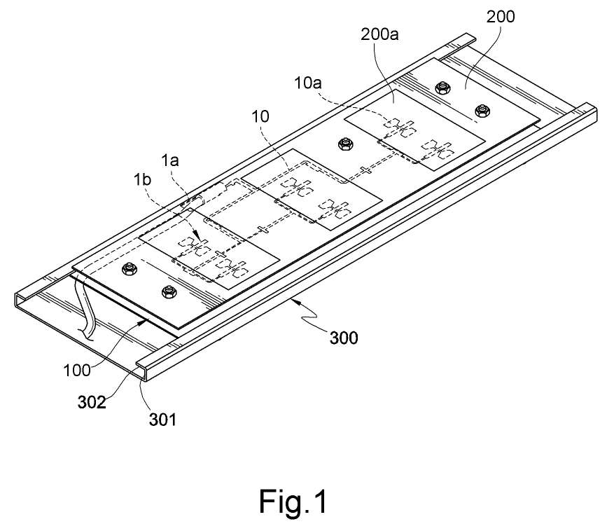

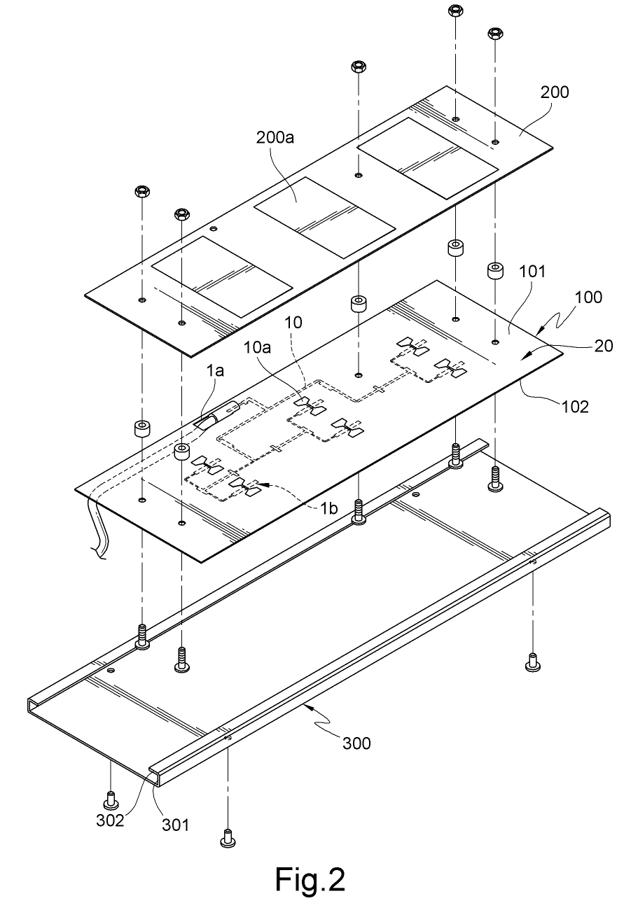

FIG. 1 is a schematic view of a first embodiment of the present invention. FIG. 2 is an exploded view of the first embodiment of the present invention. For the convenience of illustration, referring to FIG. 2, a slot-coupled microstrip antenna includes a first substrate 100, a second substrate 200, and a support base 300.

The first substrate 100 has a first surface 101 and a second surface 102. A ground surface 20 is formed on the first surface 101, and a feeding network 10 is formed on the second surface 102. Slots 10a are formed on the ground surface 20, and an embodiment of the slots 10a may be H-shaped, but also can be in a geometrical shape such as a rectangle, square, and round. Microstrip antennae 200a are formed on a plane of the second substrate 200 with a back towards the first substrate 100. The first substrate 100 is generally a printed circuit board (PCB). Certainly, other types of substrates are also applicable. Moreover, the first substrate 100 may be a hard board or a flexible soft board. A material of the hard board is glass fiber, Bakelite or other materials, and a material of the flexible soft board is polyimide (PI), polyethylene terephthalate (PET), or other materials.

The second substrate 200 is above the first surface 101 of the first substrate. The plurality of microstrip antennae 200a is formed on the second substrate 200. The support base 300 is below the second surface 102 of the first substrate 100, and two grooves 301 extend from two sides of the support base 300. The grooves 301 on two sides of the support base 300 are used to accommodate edges of the first substrate 100. The first substrate 100 and the second substrate 200 can be selectively fixed and supported by screws and nuts, or be supported by other non-metal objects. The support base 300 may be in a geometrical shape such as L or arc. A material of the support base is selected from the group consisting of iron, aluminum, stainless steel, and aluminum-magnesium alloy.

When a feed signal is fed in from a signal feed portion 1a, the feeding network 10 of the microstrip circuit transmits the feed signal to a corresponding radiation unit 1b. In order to achieve the operating characteristics of broad bandwidth and high gain, air is used as a dielectric. The slots 10a in the ground surface 20 are not a continuous face with respect to a position of the radiation unit 1b on the second surface 102. When the air is used as the dielectric, the forward radiation of the feed signal is transmitted and coupled to the microstrip antennae 200a corresponding to the position of the slots 10a on the second substrate 200, so as to radiate the feed signal through the microstrip antennae 200a. However, not only forward radiation of the antenna will be generated at the position of the slots 10a, backward radiation of the antenna will also be generated at the same time. At this time, the support base 300 reflects and concentrates the backward radiation of the antenna within the angle and scope of the forward radiation of the antenna, so as to increase the front-to-back ratio. Meanwhile, as the edges of the first surface 101 of the first substrate 100 are adjacent to edges 302 of the two grooves 301 of the support base 300, the level of the cross polarization can be inhibited effectively.

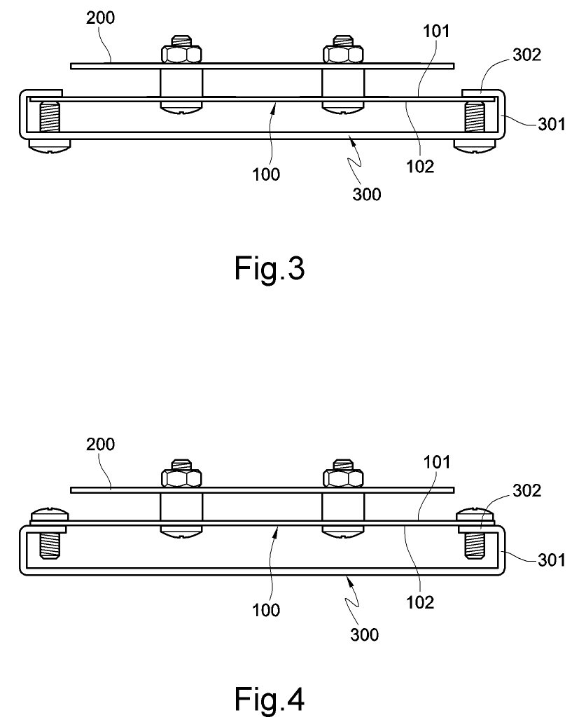

FIG. 3 is a side view of the first embodiment of the present invention. Referring to FIG. 3, the edges 302 of the two grooves 301 of the support base 300 are adjacent to edges of the first surface 101 of the first substrate 100. The edges of the first surface 101 of the first substrate 100 can be attached and fixed to the edges 302 by means of screws and nuts or other methods.

FIG. 4 is a side view of a second embodiment of the present invention. Referring to FIG. 4, the main difference between the two embodiments is as follows. In the second embodiment, the first substrate 100 is not covered by the two grooves 301 of the support base 300 tightly, but is disposed outside the two grooves 301 of the support base 300, and the edges of the second surface 102 of the first substrate 100 are adjacent to outer sides of the two grooves 301 on two sides of the support base 300. The edges of the second surface 102 of the first substrate 100 can be attached and fixed to the outer sides of the two grooves 301 of the support base 300 by means of screws or other methods.

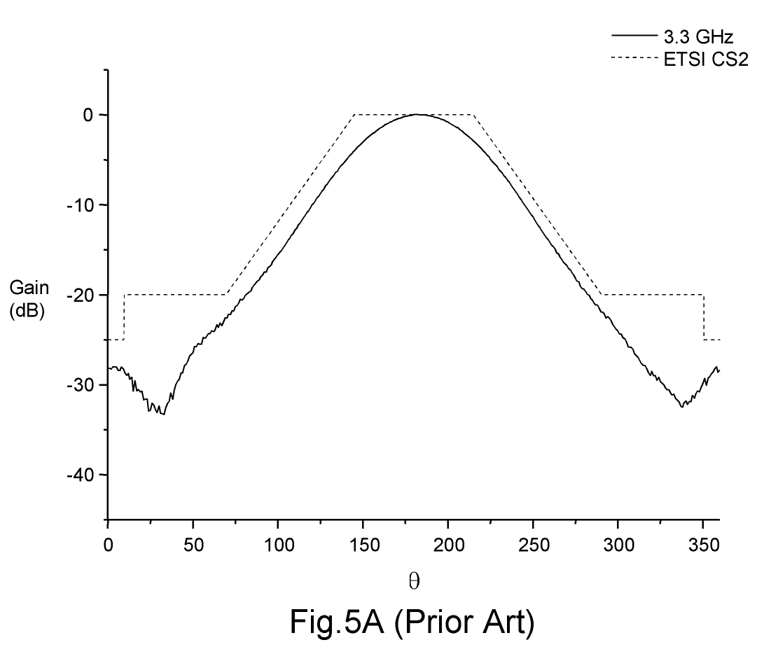

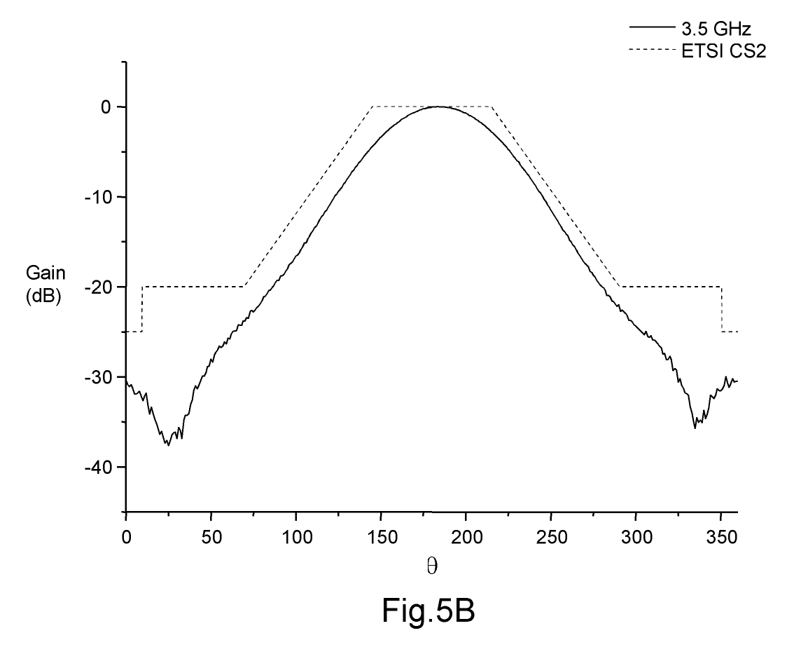

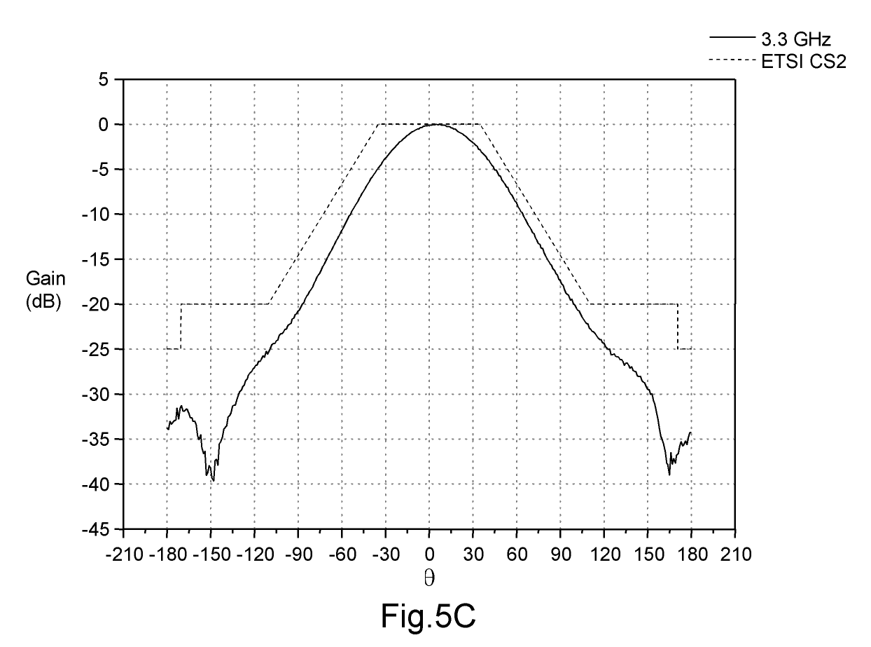

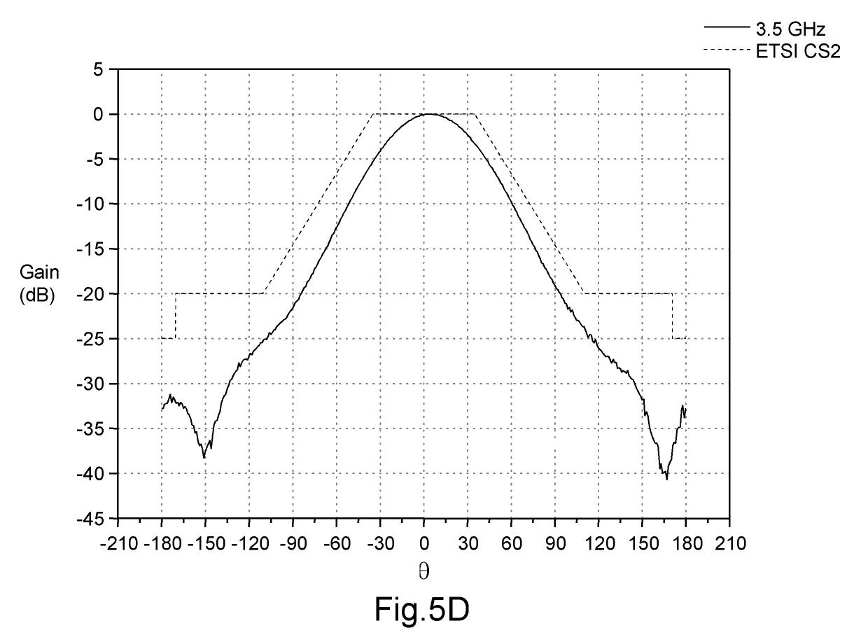

FIGS. 5A and 5B are diagrams showing the measurement of horizontal plane co-polarization of the prior art at the frequencies 3.3 GHz and 3.5 GHz respectively, and FIGS. 5C and 5D are diagrams showing the measurement of horizontal co-polarization of the slot-coupled microstrip antenna of the present invention at the frequencies 3.3 GHz and 3.5 GHz respectively. Referring to FIGS. 5A, 5B, 5C, and 5D, it is found that when the prior art is applied at the frequencies of 3.3 GHz and 3.5 GHz respectively, the sidelobe wave number is over −30 dB, but when the slot-coupled microstrip antenna of the present invention is applied at the frequencies of 3.3 GHz and 3.5 GHz respectively, the sidelobe wave number is lower than −30 dB. Therefore, the slot-coupled microstrip antenna of the present invention can increase the front-to-back ratio.

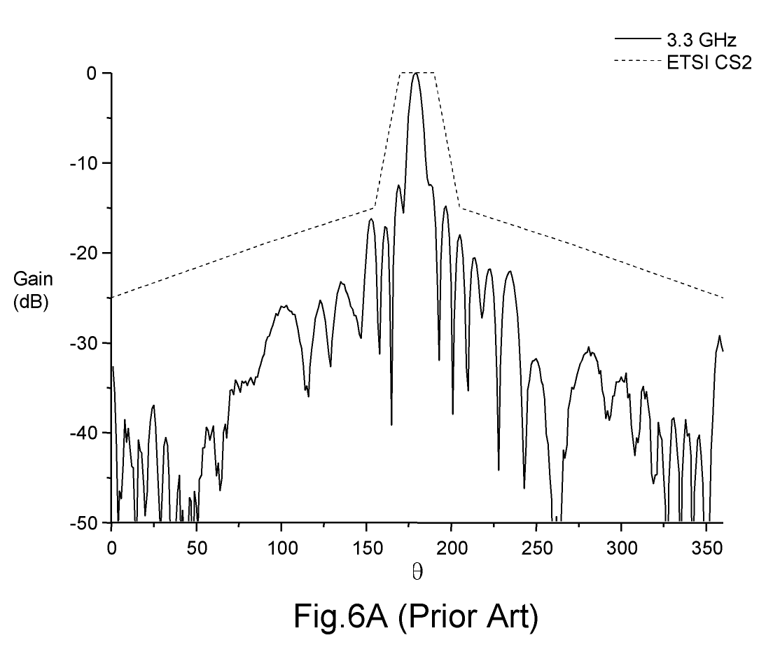

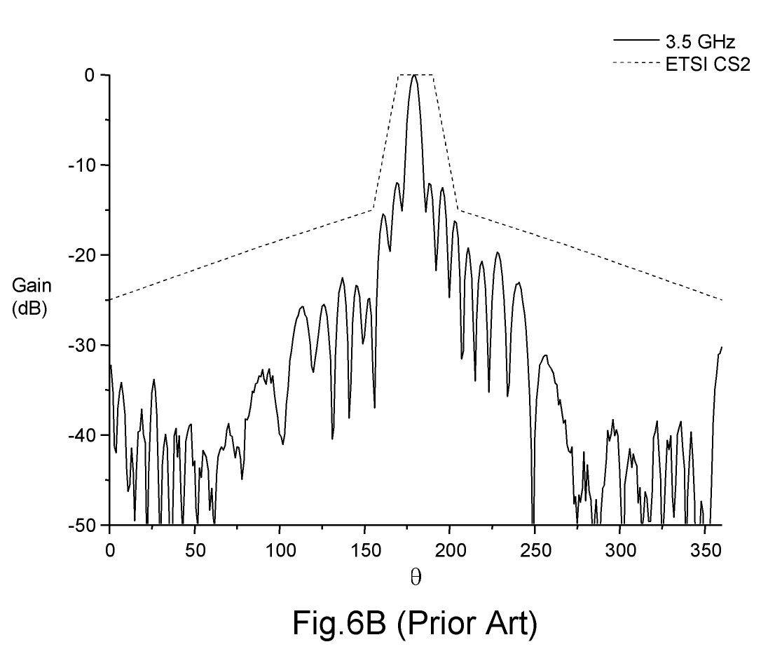

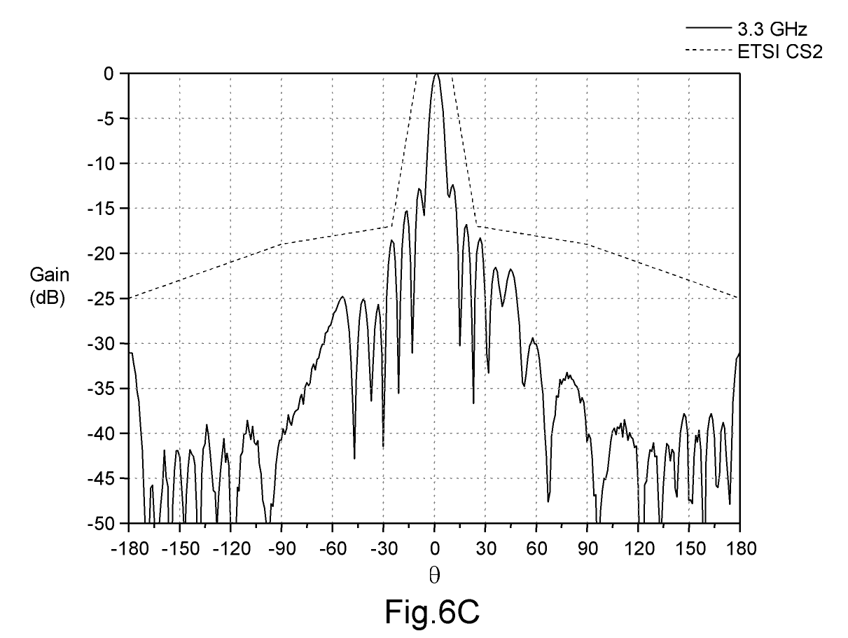

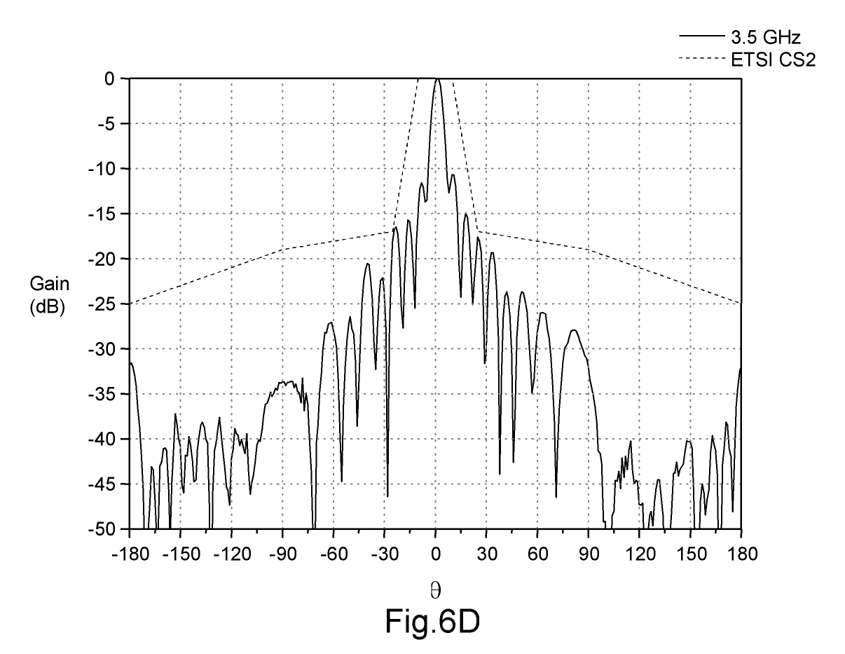

FIGS. 6A and 6B are diagrams showing the measurement of vertical plane co-polarization of the prior art at the frequencies 3.3 GHz and 3.5 GHz respectively, and FIGS. 6C and 6D are diagrams showing the measurement of vertical co-polarization of the slot-coupled microstrip antenna of the present invention at the frequencies 3.3 GHz and 3.5 GHz respectively. Referring to FIGS. 6A, 6B, 6C, and 6D, it is found that when the prior art is applied at the frequencies of 3.3 GHz and 3.5 GHz respectively, the sidelobe wave number is over −30 dB, but when the slot-coupled microstrip antenna of the present invention is applied at the frequencies of 3.3 GHz and 3.5 GHz respectively, the sidelobe wave number is lower than −30 dB. Therefore, the slot-coupled microstrip antenna of the present invention can increase the front-to-back ratio.

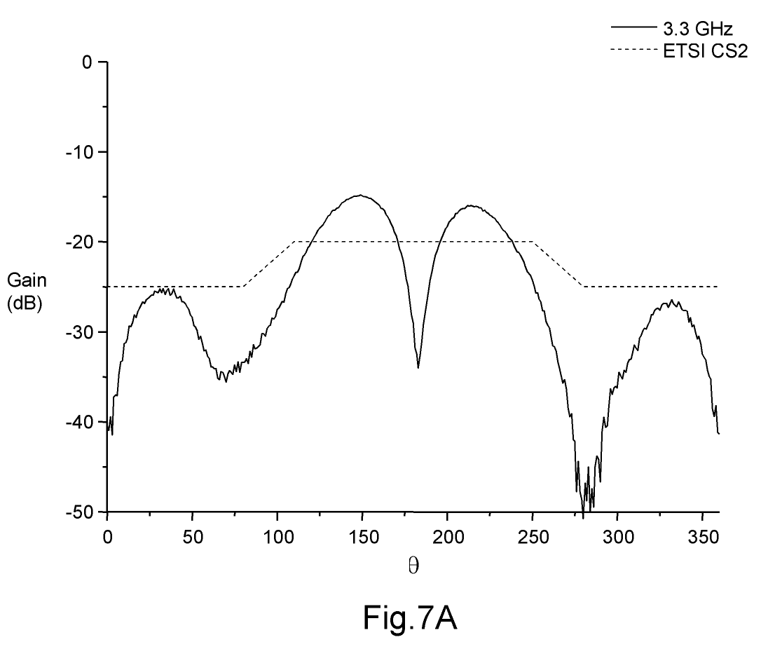

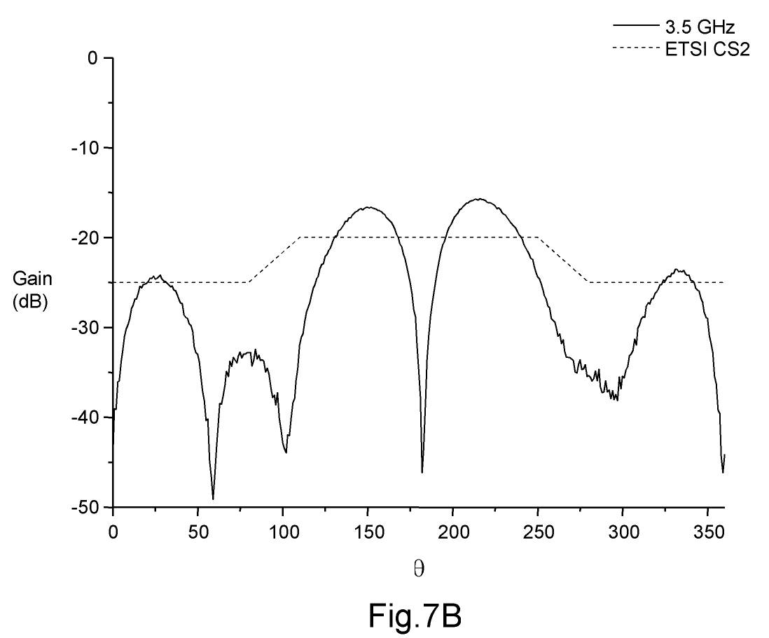

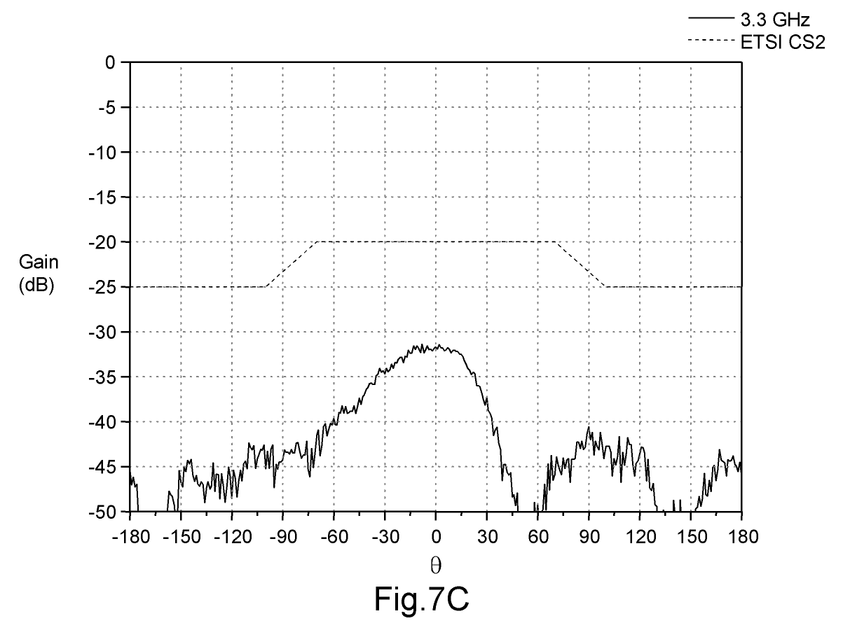

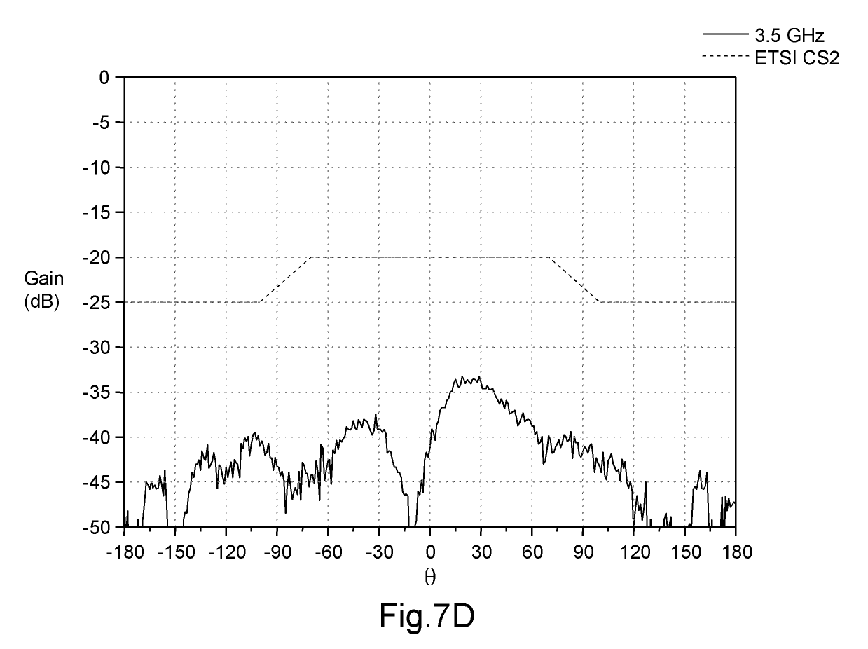

FIGS. 7A and 7B are diagrams showing the measurement of horizontal plane cross polarization of the prior art at the frequencies 3.3 GHz and 3.5 GHz respectively, and FIGS. 7C and 7D are diagrams showing the measurement of horizontal cross polarization of the slot-coupled microstrip antenna of the present invention at the frequencies 3.3 GHz and 3.5 GHz respectively. Referring to FIGS. 7A, 7B, 7C, and 7D, it is found that when the prior art is applied at the frequencies of 3.3 GHz and 3.5 GHz respectively, the cross polarization gain exceeds the intelligent network standard CS2 defined by European Telecommunication Standards Institute (ETSI), but when the slot-coupled microstrip antenna of the present invention is applied at the frequencies of 3.3 GHz and 3.5 GHz respectively, the cross polarization gain is much lower than CS2 defined by ETSI. Therefore, the slot-coupled microstrip antenna of the present invention can effectively inhibit the level of cross polarization.

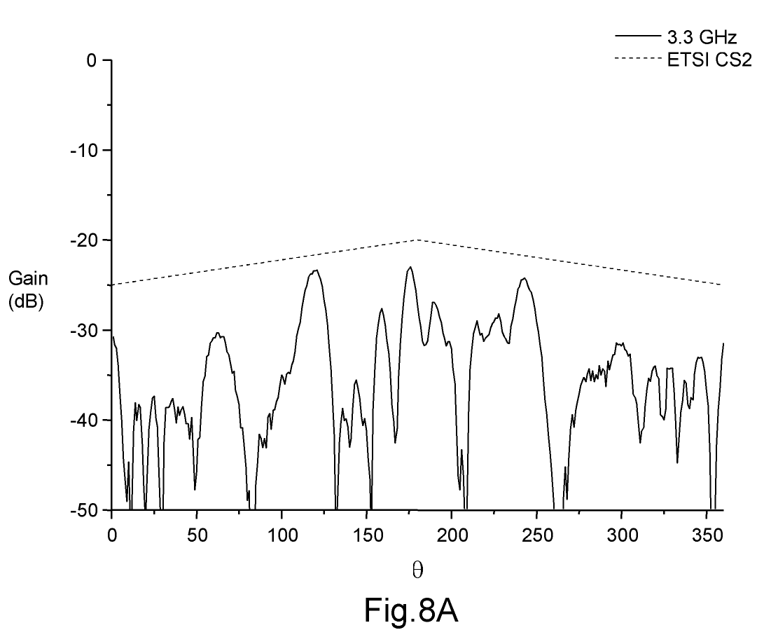

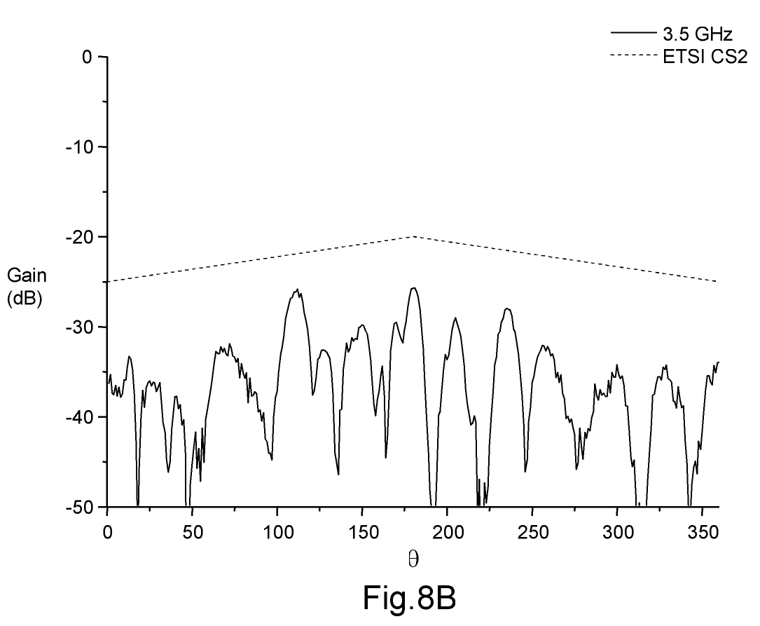

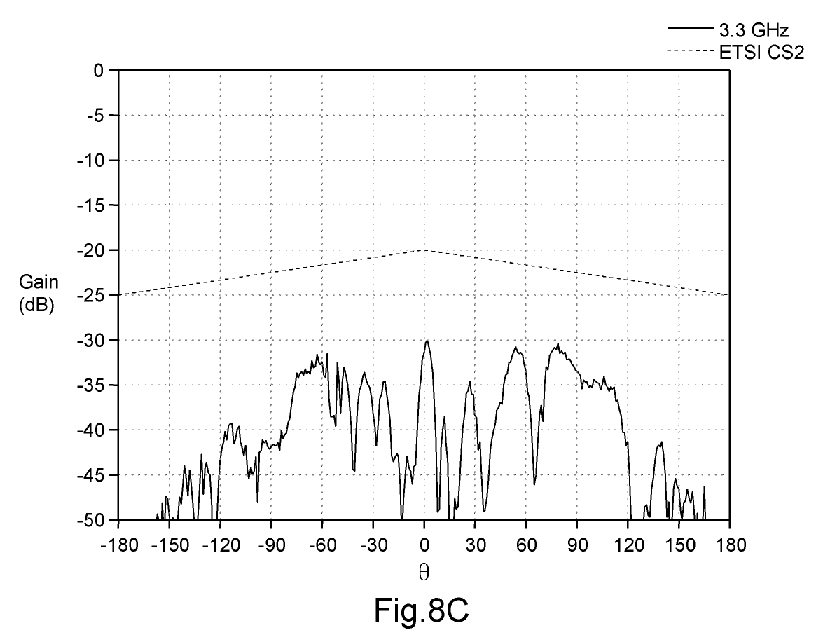

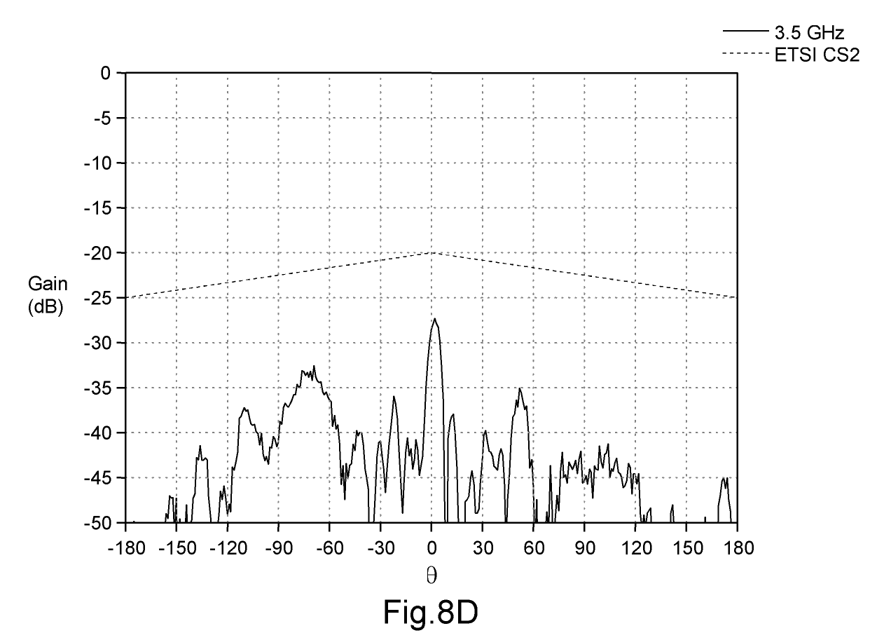

FIGS. 8A and 8B are diagrams showing the measurement of vertical plane cross polarization of the prior art at the frequencies 3.3 GHz and 3.5 GHz respectively, and FIGS. 8C and 8D are diagrams showing the measurement of vertical cross polarization of the slot-coupled microstrip antenna of the present invention at the frequencies 3.3 GHz and 3.5 GHz respectively. Referring to FIGS. 8A, 8B, 8C, and 8D, it is found that when the slot-coupled microstrip antenna of the present invention is applied at the frequencies of 3.3 GHz and 3.5 GHz respectively, the cross polarization gain is obviously lower than that of the prior art when it is applied at the frequencies of 3.3 GHz and 3.5 GHz respectively. Therefore, the slot-coupled microstrip antenna of the present invention can effectively inhibit the level of cross polarization.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A slot-coupled microstrip antenna, comprising:
a first substrate, having a first surface and a second surface, wherein a ground surface is formed on the first surface, a plurality of slots is formed on the ground surface, and a feeding network is formed on the second surface;
a second substrate, disposed below the first surface, wherein a plurality of microstrip antennae is formed on the second substrate, the microstrip antennae are corresponding to the slots, for radiating a feed signal coupled by the slots; and
a support base, disposed under the second surface, having two grooves on both sides, wherein edges of the two grooves are adjacent to two edges of the first substrate.

2. The slot-coupled microstrip antenna as claimed in claim 1, wherein a material of the support base is selected from the group consisting of iron, aluminum, stainless steel, and aluminum-magnesium alloy.

3. The slot-coupled microstrip antenna as claimed in claim 1, wherein the first substrate and the second substrate are supported by a plurality of support parts.

4. The slot-coupled microstrip antenna as claimed in claim 3, wherein the support parts use screws and nuts for fixing and support.

5. The slot-coupled microstrip antenna as claimed in claim 1, wherein the edges of the first substrate are accommodated in the grooves.

6. The slot-coupled microstrip antenna as claimed in claim 1, wherein the edges of the first substrate are adjacent to outer sides of the grooves.

7. The slot-coupled microstrip antenna as claimed in claim 6, wherein the edges of the first substrate are fixed to the outer sides of the grooves with screws and nuts.
